(19) United States
(12) Patent Application Publication
(10) Pub. No.: US 2004/0214605 A1
(43) Pub. Date: Oct. 28, 2004

(54) Adaptable multi-band antenna system

(76) Inventors: Da Ming Zhang, Singapore (SG); Er Ping Li, Singapore (SG); Sheng Wang, Singapore (SG)

Correspondence Address: COATS & BENNETT, PLLC, P O BOX 5, RALEIGH, NC, 27602, US

(21) Appl. No.: 10/424,971

(22) Filed: Apr. 28, 2003

(51) Int. Cl. H04B 1/38

(52) U.S. Cl. 455/562.1; 455/561

(57) ABSTRACT

An adaptable antenna system includes a switched-segment antenna having an adjustable electrical length, such that the frequency band of the antenna may be changed to adapt the antenna for use at different frequencies. In an exemplary embodiment, a microprocessor-based control circuit monitors a detection circuit that includes an array of frequency-selective magnetic field sensors. These H-field sensors drive a corresponding array of RF frequency resonators, such that a particular resonator circuit is vibrated responsive to a center frequency of an incident electromagnetic signal matching the sensing frequency of one of the H-field sensors. The control circuit detects the frequency of the incident signal by determining which resonator circuit is active and drives an antenna interface to selectively open and close inter-segment switches in the antenna to adjust its length to a frequency band appropriate for the detected frequency. The antenna may be reconfigured in response to detecting a new frequency.

### BACKGROUND OF THE INVENTION

The present invention generally is related to antennas, and particularly is related to adaptable multi-band antennas.

Wireless communication systems oftentimes operate within a single frequency band, such as the 800 MHz frequency band defined for the IS-95B standards for CDMA-based cellular radio communication, or the 2.45 GHz frequency band defined for the IEEE 802.11b standards defined for short-range wireless networking. Naturally, such systems use antennas that are tuned for favorable performance at the frequency band of interest. For example, a given wireless communication device might be configured with a dipole antenna having an electrical length fixed at a half wavelength of the frequency of interest. Such a half wavelength configuration for the dipole configuration yields maximum power transfer for signals at the frequency of interest because antenna resonance at that frequency results in the antenna's inductive reactance canceling its capacitive reactance. A similar maximum power transfer configuration is achieved for the grounded monopole antenna by setting its electrical length to a quarter wavelength of the frequency of interest.

Such results suggest that one simply should equip a given radio frequency receiver, transmitter, or transceiver, with a half wavelength dipole or quarter wavelength monopole as desired. However, the use of a fixed length antenna becomes problematic for systems intended to operate a multiple frequency bands. Such multi-band applications typically employ so-called multi-band antennas that may be configured for operation in one of two or more frequency bands. Examples of configurable antennas may be found, for example, in U.S. Pat. No. 6,384,797 and in U.S. Pat. No. 5,541,614, which introduce the use of Micro-Electro-Mechanical-Switches (MEMS) to make the length of antennas physically changeable.

However, current antenna systems do not offer an integrated system for detecting frequencies of interest and adapting a configurable antenna to a corresponding frequency band. Ideally, such a system would offer reliable detection of the frequency for a signal of interest, and provide an antenna structure that complements adaptable configuration of the antenna's electrical length in response to the detected frequency.

### SUMMARY OF THE INVENTION

The present invention comprises a method and apparatus to detect a frequency of an electromagnetic signal of interest, and to change a combined segment length of a switched-segment antenna responsive to the detected frequency, such that a frequency band of the antenna is set based on the detected frequency. Thus, according to the present invention, an antenna system provides adaptable, multi-band antenna whose effective electrical length and, therefore, frequency band, changes in response to changes in the detected frequency.

An exemplary method of antenna adaptation comprises detecting a frequency of an incident electromagnetic signal using a detection circuit that includes an array of frequency-selective H-field sensors and, setting a combined segment length of the switched-segment antenna by selectively opening and closing inter-segment switches to configure the switched-segment antenna for the desired frequency band.

Thus, the exemplary method controls a switched-segment antenna having a configurable combined segment length, wherein a combined segment length of the antenna is adjusted responsive to detecting a frequency of a signal of interest. The detected frequency may be a center frequency of an electromagnetic wave incident on the H-field sensor array within the detection circuit, and the antenna system may thus adjust its frequency band to match to the center frequency of a received electromagnetic signal.

In an exemplary embodiment, the antenna system comprises a switched-segment antenna that includes two or more conductive antenna segments, with each segment having a defined length, and one or more inter-segment switches to selectively interconnect neighboring, i.e., adjacent, conductive segments such that a combined segment length of the antenna is set by selectively opening and closing the inter-segment switches. The exemplary system further comprises a detection circuit to detect a frequency of an electromagnetic signal of interest, an antenna interface circuit to control the inter-segment switches, and a control circuit to generate control signals for the antenna interface circuit responsive to monitoring the detection circuit.

An exemplary embodiment of the detection circuit includes the aforementioned array of H-field sensors, wherein the H-field sensor output signals are coupled directly or indirectly to respective ones in a corresponding array of RF frequency resonator circuits. An exemplary frequency resonator circuit is based on a polycrystalline silicon beam structure that is “tuned,” or is otherwise configured, to respond to a particular frequency. The control circuit determines the frequency of the electromagnetic wave that is incident on the sensor array by identifying which one of the H-field sensors “responds” to the signal of interest, as indicated by assertion of the corresponding resonator circuit's output signal.

In an exemplary embodiment of the detection circuit, each H-field sensor output signal is coupled to the corresponding frequency resonator circuit through a down-converter that mixes the sensor output signal down to a baseband signal, which is then amplified and input to the corresponding frequency resonator. With this configuration, then, the control circuit monitors the resonator output signals, to determine which H-field sensor is active. That is, when an incident waveform impinges on the H-field sensor array, the sensor having a matching frequency becomes active, and its corresponding frequency resonator asserts its resonator output signal (detection output signal) for detection by the control circuit.

Supporting such functionality, an exemplary control circuit includes a digital logic circuit, such as a microprocessor circuit, that is programmed to control the switched-segment antenna responsive to identifying the appropriate frequency band for the antenna based on its monitoring of the detection circuit's detection output signals. The term “microprocessor” is given broad construction herein and includes so-called microcontrollers that offer extensive digital I/O, and which may be preferable for monitoring discrete detector output signals and for providing discrete control output signals for controlling the antenna interface.

Regardless, an exemplary antenna interface circuit includes a plurality of switch control circuits, which may be implemented as relay control circuits that each include a logic circuit coupled to a relay drive circuit. The relay drive circuits each actuate one or more inter-segment switches in the switched-segment antenna. An exemplary logic circuit provides an input to receive a detection output signal, such that receiving an electromagnetic signal at the detection circuit actuates one or more inter-segment switches in the switched-segment antenna, and further provides an additional input to receive a microprocessor-controlled signal, such that each relay control circuit may be driven additionally or alternatively by the control circuit.

Complementing the antenna interface circuit's relay control circuits, an exemplary switched-segment antenna comprises a non-conductive central support, and two or more conductive antenna segments surrounding the support. For example, the central support may be implemented as a central supporting rod, and the conductive antenna segments may comprise cylindrical segments concentrically surrounding the supporting rod. Neighboring segments, that is adjacent conductive segments are selectively connected and disconnected by an inter-segment switch that is actuated via the switch control circuits in the antenna interface. As such, the signal lines to the inter-segment switches may be run within an interstitial space between the central support and the surrounding conductive segments. In a dipole configuration, the inter-segment switches may be configured such that corresponding dipole segments are switched in and out to maintain symmetry between the dipole elements.

In general, the present invention comprises an adaptive multi-band antenna system that changes, or otherwise adjusts, the effective electrical length of a switched-segment antenna responsive to detecting the frequency of an electromagnetic signal of interest. Those skilled in the art will appreciate additional features and advantages upon reading the following detailed description of exemplary embodiments of the present invention, and upon inspection of the accompanying drawings. However, the following details should be understood as exemplary, and should not be construed as limiting the present invention.

### BRIEF DESCRIPTION OF THE DRAWINGS

FIG. 1 is a diagram of an exemplary antenna system according to the present invention.

FIG. 2 is a diagram of exemplary details for the antenna system of FIG. 1.

FIG. 3 is a diagram of an exemplary detection circuit.

FIGS. 4A-4C are diagrams of exemplary H-field sensor circuit details.

FIG. 5 is a diagram of an exemplary antenna interface circuit.

FIG. 6 is a diagram of an exemplary switch-segment antenna in a dipole configuration, and illustrates inter-segment switch configurations for operation of the antenna in selectable frequency bands.

FIG. 7 illustrates inter-segment switch configurations for selectable frequency bands for a monopole embodiment of the switched segment antenna.

FIG. 8 illustrates exemplary cross-sectional details for the switched-segment antenna of FIGS. 6 and 7, for example.

FIG. 9 illustrates an exemplary vertical radiation pattern for a dipole antenna system according to the present invention.

FIG. 10 illustrates an exemplary horizontal radiation pattern for a dipole antenna system according to the present invention.

### DETAILED DESCRIPTION OF THE INVENTION

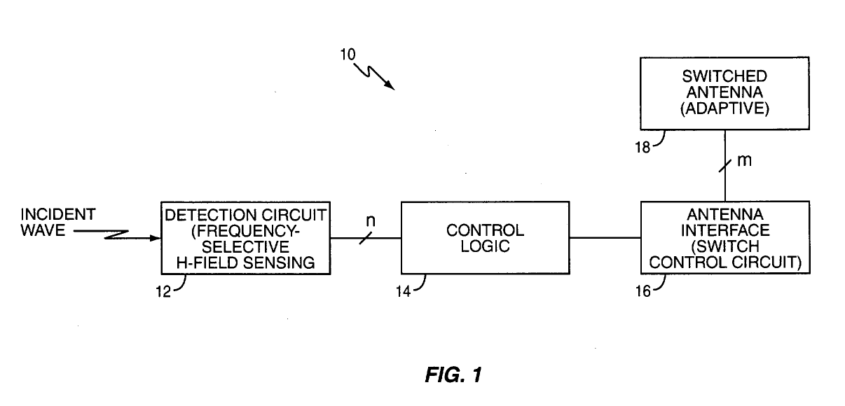

Referring to FIG. 1, an exemplary antenna system, generally referred to by the numeral 10, comprises a detection circuit 12, a control circuit 14, an antenna interface circuit 16, and a switched-segment antenna 18. In general, the control circuit 14 monitors the detection circuit 12, which provides one or more signals that indicate the frequency of an electromagnetic signal incident on the detection circuit 12. In response, the control circuit 14 generates one or more control signals for input to the antenna interface circuit 16, which sets one or more inter-segment switches (not shown) within the switched-segment antenna 18, such that the frequency band of the antenna 18 is changed responsive to the detected frequency of the electromagnetic signal of interest.

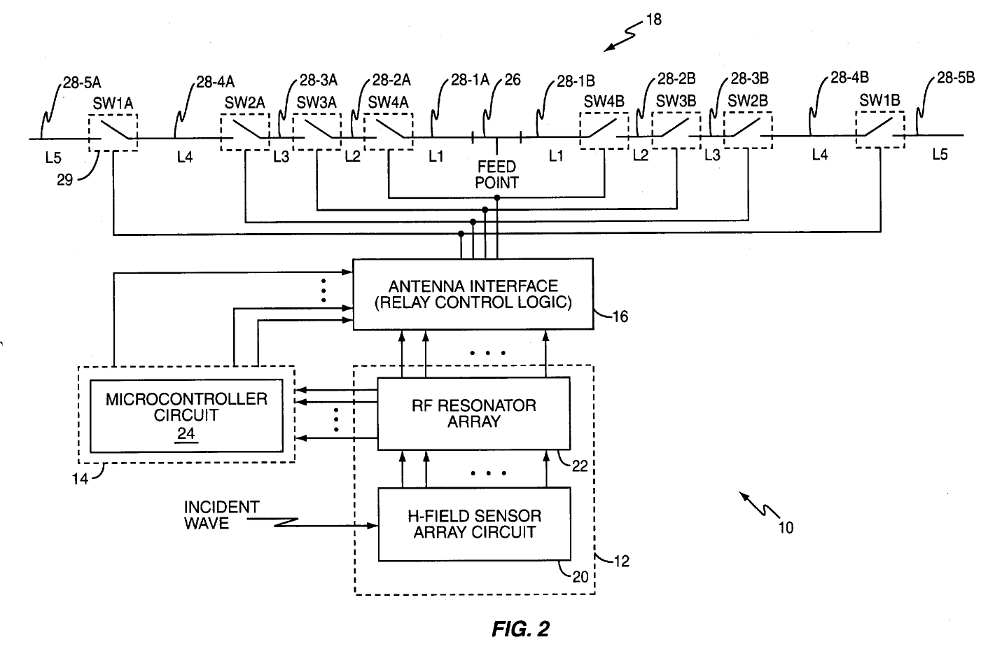

FIG. 2 illustrates exemplary details for the antenna system 10. As shown, an exemplary detection circuit 12 includes an array of magnetic field sensor circuits 20 (H-field sensors) configured to detect a magnetic field at different frequencies, and further includes a corresponding array of resonator circuits 22. In an exemplary embodiment, the detection circuit 12 includes sensor circuits and corresponding resonator circuits for each frequency of interest.

H-field sensor output signals from the sensor circuits 20 couple directly or indirectly to the control circuit 14 for monitoring thereof. Here, the sensor output signals couple indirectly through an array of radio frequency (RF) resonator circuits 22. Thus, in this embodiment, the control circuit 14 detects the frequency of the electromagnetic signal incident on the array of H-field sensor circuits 20 by identifying which RF resonator circuit's output signal is “active,” or otherwise asserted responsive to the signal incident on the array of sensor circuits 20.

In an exemplary control circuit 14, a microprocessor circuit 24 monitors the detection output signals from the detection circuit 12. The detection output signals identify which frequency was detected by the array of H-field sensor circuits 20, and thus permits the microprocessor circuit 24 to determine the appropriate frequency band for the antenna 18. Exemplary but non-limiting microcontroller choices for implementing microprocessor circuit 24 include the INTEL 80C51 microcontroller and the MOTOROLA 68HC05 microcontroller, both of which are low-cost and readily available. In other implementations, one might implement the digital logic of microprocessor circuit 24 using an ASIC or FPGA, or other programmable device.

In any case, an exemplary switched-segment antenna 18 may be implemented in a dipole configuration. Here, antenna 18 comprises conductive segments 28, i.e., 28-1A/B, 28-2A/B, and so on, that are selectively interconnected by inter-segment switches, SW1A/B, SW2A/B, and so on, under control of microprocessor circuit 24 such that the antenna system 10 functions as an adaptable multi-band antenna, wherein the antenna's frequency band is adjusted by changing the combined segment length responsive to the detected frequency. Note that the combined segment lengths for each side of the dipole are controlled together to maintain antenna symmetry. Thus, SW1A is opened or closed together with SW1B, SW2A is opened or closed in unison with SW2B, and so on.

Operating under control of the control circuit 14, the antenna interface circuit 16 opens all inter-segment switches to obtain the shortest segment length (L1), closes SW4A and SW4B to obtain the next shortest combined segment length (L1+L2), and so on. With all switches closed, the combined segment length for each side of the dipole is L1+L2+L3+L4+L5. By setting the open/closed state of inter-segment switches SW1A/B . . . SW5A/B appropriately, one obtains combined segment lengths that correspond to desired frequency bands. In an advantageous embodiment, the length L1 is set to a half wavelength of a frequency of interest, the combination of L1+L2 is set a half wavelength of another frequency of interest, and so on. For a monopole configuration, the combinations of segment lengths may be set for quarter wavelengths of different frequencies of interest.

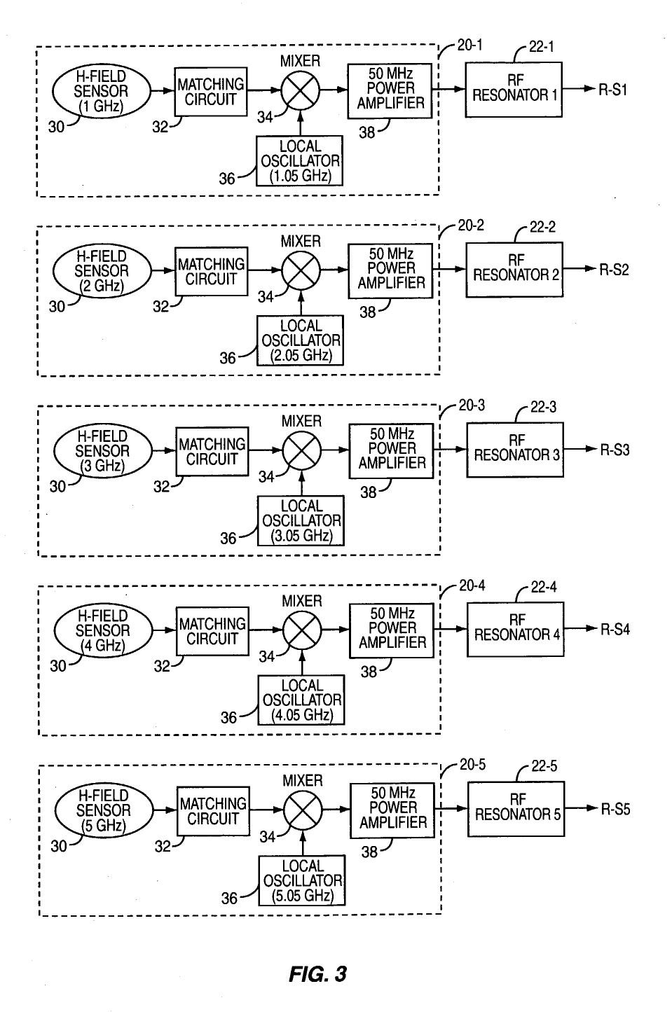

Turning now to exemplary details for detecting the frequency of an incident electromagnetic wave in support of setting the matching combined segment length of antenna 18, FIG. 3, illustrates exemplary details for the array of H-field sensor circuits 20. Here, the array includes sensor circuits 20-1 through 20-5, which are similar in construction with the exception that each one is “tuned” to detect a different frequency of interest. Thus, it is sufficient to describe the exemplary details for sensor circuit 20-1.

Sensor circuit 20-1 comprises an H-field sensor 30, a matching circuit 32, a mixer circuit 34, a local oscillator 36, and a power amplifier 38. With this configuration, an H-field sensor output signal is coupled through the matched impedance circuit 32 for maximum power transfer, i.e., better detection sensitivity, into the mixer circuit 34. Mixer circuit 34 down-converts the sensor output signal to a baseband signal, which is a 50 MHz baseband signal in this embodiment, for input to a power amplifier 38. Down-conversion to a baseband signal permits use of a lower frequency resonator circuit 22-1, and a more moderate bandwidth power amplifier circuit. The amplified, baseband signal output by the power amplifier 38 provides a robust input signal for RF resonator circuit 22-1, which forms an exemplary part of the array of resonator circuits 22. Note that where the frequencies of interest, i.e., the frequencies to be detected, are within a practical bandwidth for input to resonator circuit 22-1, the H-field sensor 30 may be coupled directly to the resonator circuit 22-1.

As noted, each sensor circuit, i.e., 20-1, 20-2, and so on, is configured to detect a different frequency of interest. Thus, for an exemplary embodiment intended to detect frequencies at about 1 GHz, 2 GHz, 3 GHz, 4 GHz, and 5 GHz, the H-field sensors 30 in sensor circuits 20-1 through 20-5 are configured for 1 GHz detection, 2 GHz detection, and so on. Complementing this, the mixer circuit 34 and local oscillator 36 in each sensor circuit 20 is configured for a corresponding down-conversion frequency. Thus, local oscillator 36 in sensor circuit 20-1 operates at 1.05 GHz to down-convert the 1 GHz detector output signal to a 50 MHz baseband signal. For this exemplary configuration, the local oscillator frequencies in the other sensor circuits 20 are 2.05 GHz, 3.05 GHz, 4.05 GHz, and 5.05 GHz.

Each H-field sensor 30 may comprise a conductive or resistive loop, and the loop may be sized for the particular frequency band of interest and coupled to a corresponding one of the matching circuits 32. In an exemplary embodiment, the sensing and control portions of the antenna system are implemented on a printed circuit board (PCB), and the detection circuits 20 may be implemented such that each H-field sensor 30 is integrated into or otherwise formed on the PCB. Preferably, the H-field sensors 30 would be positioned on the PCB nearby or at the point where the switched-segment antenna 18 is coupled to the antenna interface circuit 16.

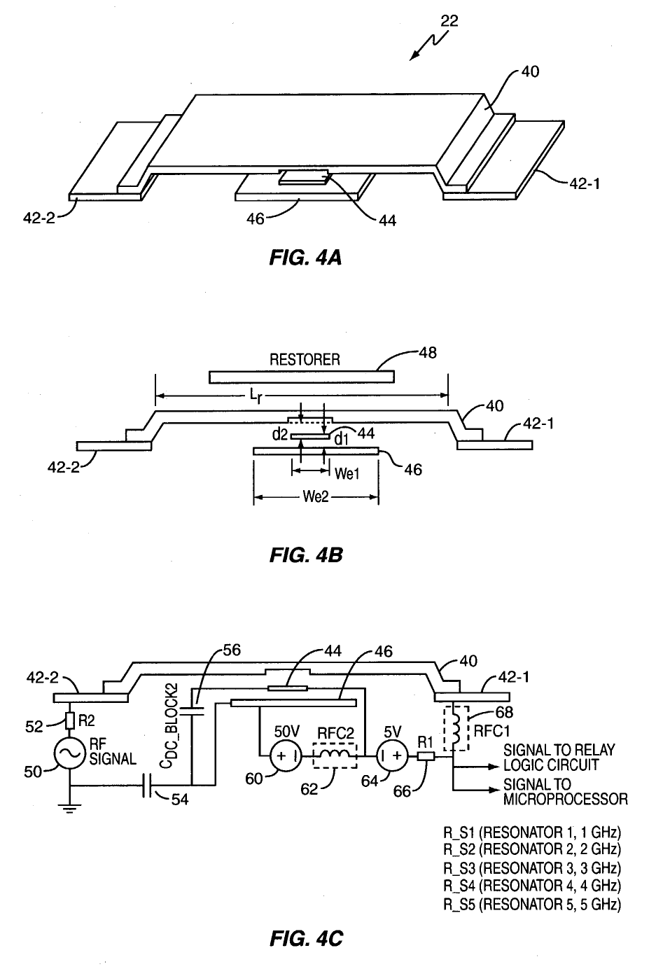

FIGS. 4A-4C illustrate exemplary details for resonator circuits 22-1 through 22-5. In general, the resonator circuits 22 should be designed to resonate at a desired center frequency, which, for the exemplary embodiment illustrated here, is the 50 MHz baseband frequency provided by mixer circuits 34. Also, the quality factor (Q) of the exemplary resonator circuits 22 should be relatively higher, greater than 20,000 for example, to achieve high sensitivity to the resonator input signal, i.e., the H-field sensor output signals.

FIG. 4A illustrates an exemplary physical construction for an RF resonator circuit 22, which includes a polycrystalline silicon resonating beam 40 positioned on end terminations 42-1 and 42-2, first and second electrodes 44 and 46. FIG. 4B provides additional physical details, and further illustrates the use of an optional restoring beam 48, the use of which is explained later herein. FIG. 4C illustrates exemplary electrical details for the resonator circuit 22, which include the resonator beam 40, first and second electrodes 44 and 46, as shown before, and further include a RF signal source 50, e.g., the incident electromagnetic wave (signal), a first coupling resistor 52, dc blocking capacitors 54 and 56, a bias voltage source 60, a first RF choke 62, a supply voltage 64, a second coupling resistor 66, and a second RF choke 68.

In operation, the resonator circuit 22 asserts its resonator output signal (R_Sx) responsive to receiving an input RF signal from its corresponding H-field sensor circuit 20. That output signal may be coupled to both the control circuit 14 for frequency detection monitoring, and to the antenna interface circuit 16 for control of one or more inter-segment switches in antenna 18. In more detail, if the input RF signal is at the resonance frequency of beam 40, that beam begins vibrating. With sufficient vibration amplitude, beam 40 contacts electrode 44 and thereby “short-circuits” the signal path for the RF input signal. Resistors 52 and 66 may be used within the circuit to limit current when the resonator beam is shorted. In this regard, however, resistor 52 preferably is less than one-fifth the equivalent series resistance of the resonator to avoid splitting off too much of the input RF signal, but the output resistor 66 may be made as large as practicable for reduced power consumption. Generally, resistor 66 will be sized with respect to the signal input characteristics of the control circuit 14 and the antenna interface 16, which may be high-impedance logic gate inputs, for example.

Regardless, once shorted, the beam 40 is held by the dc electric force produced by the biasing voltage source 60, here, a 50 VDC source. The supply voltage source 64, here, a 5 VDC source, is coupled to the resonator circuit output through resistor 66, which may be made relatively large for low power operation. Thus, the resonance-induced shorting of the resonator beam 40 causes the resonator's circuit output signal to change state, such as transitioning it from a logic-high state to a logic-low state (or vice versa).

In an exemplary embodiment, the control circuit 14 monitors the detection output signals to determine when a resonator circuit 22 has asserted its output signal. The control circuit 14 determines the detected frequency by identifying which particular resonator circuit 22 is active, and generates the appropriate control signal outputs for the antenna interface 16 to configure the switched-segment antenna 18 for a frequency band that is appropriate for the detected frequency. The microprocessor circuit 24 of the control circuit 14 is, in at least one embodiment, programmed to store, or otherwise “hold” this current frequency band configuration until a different one of the resonator circuits 22 becomes active, which would indicate a change in the detected frequency.

Supporting this functionality, upon recognizing that a particular resonator circuit 22 has become active, the microprocessor circuit 24 may remove the dc bias from that resonator circuit 22, such as by disabling or disconnecting its bias voltage source 60. Further, the microprocessor circuit 24 may energize the optional restorer 48 in the activated resonator circuit 22 to restore the resonating beam 40 to its non-shorted condition. The microprocessor circuit 24 may leave this particular resonator circuit 22 un-energized until a remaining one of the resonator circuits 22 becomes active, indicating a change in the detected frequency. With this approach, then, the microprocessor circuit 24 configures the antenna 18 for a frequency band corresponding to the currently detected frequency, and holds that configuration until a new frequency is detected.

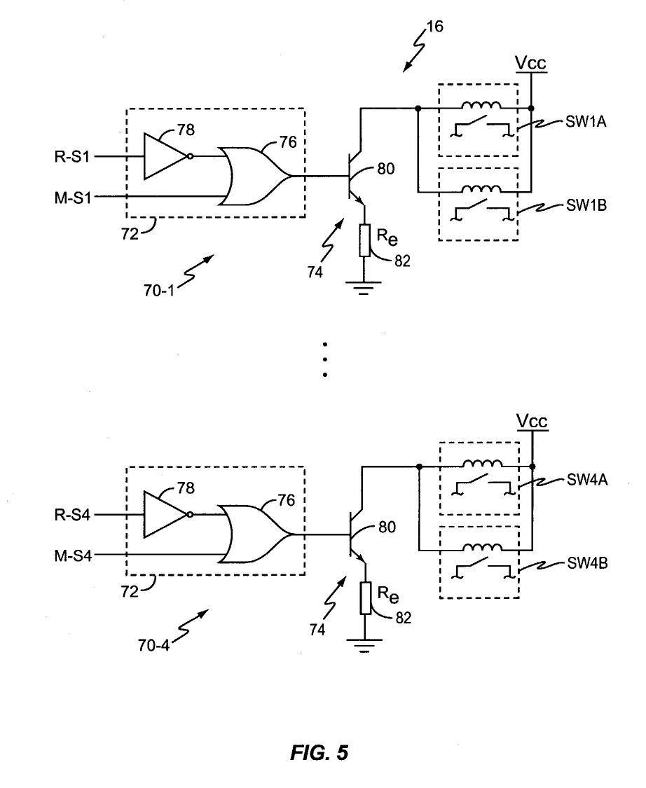

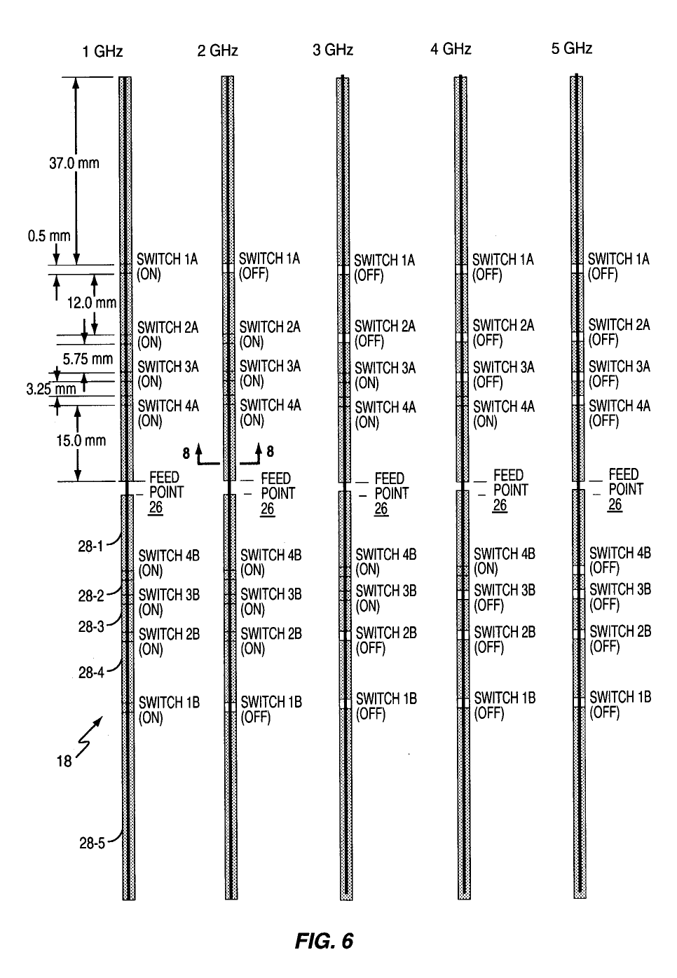

FIG. 5 illustrates an exemplary implementation of the antenna interface circuit 16. In an exemplary embodiment, the antenna interface circuit receives detection output signals from the detection circuit 12, and control output signals from the control circuit 14. These detection output and control output signals drive a plurality of relay control circuits 70-1 . . . 70-4, which, in turn, control actuation of inter-segment switches SW1A/B . . . SW4A/B. An exemplary relay control circuit 70 comprises a logic circuit 72, and a relay drive circuit 74.

An exemplary logic circuit 72 comprises an OR gate 76 and an inverter gate 78, which is used to invert the low-asserted resonator output signal (R_Sx) from the corresponding resonator circuit 22-x to a high-asserted logic signal. Of course, if different logic assertion is used, the inverter gate may not be needed. Those skilled in the art will recognize that the details of the logic circuit 72 may be varied as needed or desired. Here, the exemplary goal is to permit either or both the detection circuit 12 and the control circuit 14 to drive the relay control circuits 70. In any case, the output from logic circuit 72 serves as an input for the relay drive circuit 74, which, in an exemplary embodiment, comprises a transistor 80 with an optional emitter resistor 82.

In the illustrated example, detection circuit 12 provides five detection output signals, R_S1 through R_S5, all of which are coupled to the control circuit 14 for monitoring by the microprocessor circuit 24. Signals R_S1 through R_S4 further are coupled, respectively, to relay control circuits 70-1 through 70-4. As detection signal R_S5 corresponds to a detected frequency of 5 GHz, which requires the shortest antenna length (all switches open) it is coupled to control circuit 14 for detection purposes, but is not used to drive any of the relay control circuits 70.

With the above configuration, receiving an incident electromagnetic wave on the array of detection sensor circuits 20 causes a particular sensor circuit to respond, and therefore activates a particular one of the resonator circuits 22. Activation of a particular resonator circuit 22 causes assertion of a particular one of the resonator output signals, which drives the corresponding one of the relay control circuits 70 in the antenna interface 16, and thereby closes the corresponding inter-segment switch or switches in the antenna 18.

For example, receiving an incident wave having a 1 GHz center frequency would cause sensor circuit 20-1 to respond, and thereby provide a RF input signal 53 to the corresponding resonator circuit 22-1, which would assert its output signal R_S1. Assertion of R_S1 would drive a low-going logic signal into inverter gate 78 of relay control circuit 70-1, which would present a high-going input signal to OR gate 76, and thereby turn transistor 80 of circuit 70-1 “on,” which would close inter-segment switches SW1A and SW1B for the dipole configuration of antenna 18. Additionally, the microprocessor circuit 24 would detect assertion of R_S1 and determine the inter-segment switch configuration required to configure the antenna 18 for a frequency band appropriate for the detected 1 GHz frequency. For the illustrated antenna configuration, 1 GHz operation requires the maximum combined segment length and thus requires closure of all inter-segment switches. Therefore, in response to detecting the 1 GHz frequency of interest, the microprocessor circuit 24 would assert all of its output control signals, M_S1 . . . M_S4, and thereby close all inter-segment switches SW1A/B . . . SW4A/B to obtain the maximum combined segment length.

Continuing with exemplary antenna operations, FIG. 6 illustrates the various inter-segment switch configurations for antenna 18 corresponding to 1 GHz, 2 GHz, 3 GHz, 4 GHz, and 5 GHz frequencies of interest. If the detected frequency is about 1 GHz, the microprocessor circuit 24 asserts M_S1 . . . M_S4 to close inter-segment switches SW1A/B . . . SW4A/B for a combined segment length of L1+L2+L3+L4+L5 (for each side of the dipole). If the detected frequency is about 2 GHz, the microprocessor circuit 24 asserts M_S2 . . . M_S4 to close inter-segment switches SW2A/B . . . SW4A/B for a combined segment length of L1+L2+L3+L4 (for each side of the dipole). If the detected frequency is about 3 GHz, the microprocessor circuit 24 asserts M_S3 . . . M_S4 to close inter-segment switches SW3A/B and SW4A/B for a combined segment length of L1+L2+L3 (for each side of the dipole). If the detected frequency is about 4 GHz, the microprocessor circuit 24 asserts M_S4 to close inter-segment switch SW4A/B for a combined segment length of L1+L2 (for each side of the dipole). Finally, for a detected frequency of or about 5 GHz, the microprocessor circuit 24 holds M_S1 . . . M_S4 de-asserted so that all inter-segment switches, SW1A/B . . . SW4A/B, open, for a combined segment length of L1, i.e., the shortest possible length.

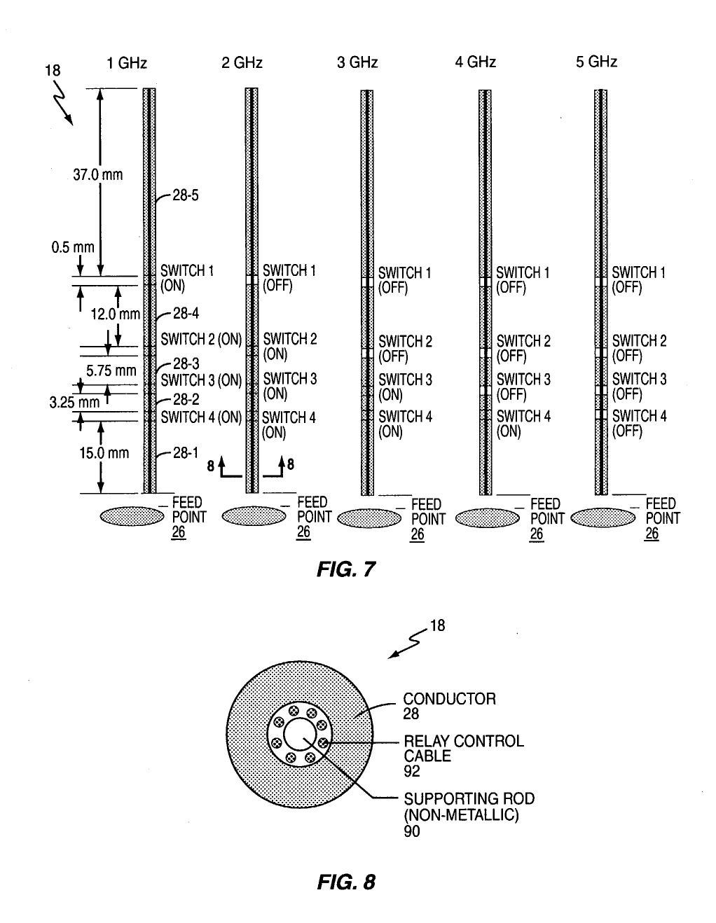

FIG. 7 illustrates similar inter-segment switch operations for a monopole version of antenna 18. Here, the combined segment length may be adjusted from L1 to L1+L2+L3+L4+L5 by selectively opening and closing the inter-segment switches SW1 . . . SW4, as needed or desired based on the detected frequency.

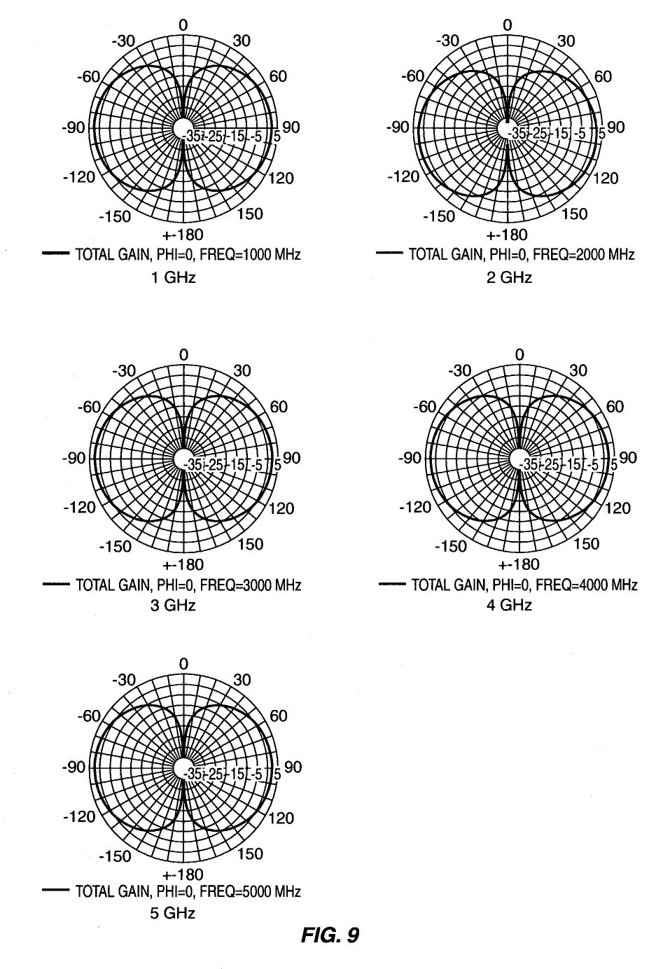

FIG. 8 is a cross-sectional view of an exemplary switched-segment antenna 18 for both dipole and monopole configurations. A non-conductive central supporting structure 90, such as a non-conductive support rod, supports the surrounding conductive antenna segments 28. In an exemplary configuration, the concentrically surrounding conductive segments 28 are sized such that switch signal conductors 92, which preferably are insulated to prevent electrical contact with the conductive segments 28, reside within an interstitial space defined between the central support 90 and the conductive segments 28. Thus, the inter-segment switches SW1A/B . . . SW4A/B, which may be MEMS, that reside within antenna 18 may be connected to the antenna interface circuit for open/close switch control via the switch cables 92 running in the interstitial space within antenna 18.

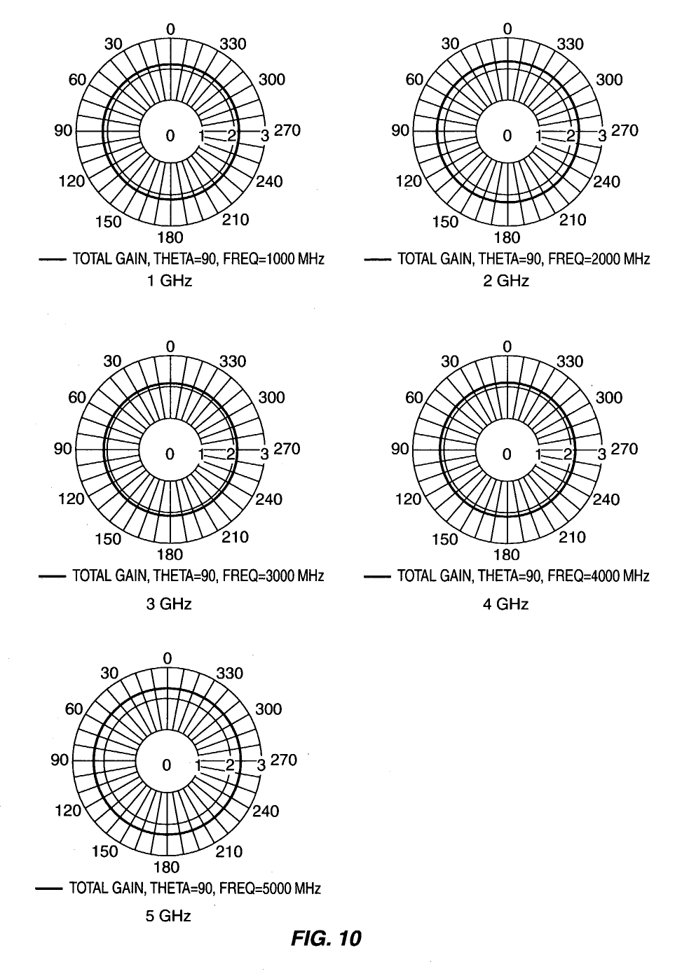

FIGS. 9 and 10 illustrate vertical and horizontal radiation patterns, respectively, for the exemplary antenna 18 in a dipole configuration. The results demonstrate that by selectively connecting and disconnecting particular conductive segments 28, the antenna 18 operates well at each desired center frequency, which in this example are 1 GHz, 2 GHz, 3 GHz, 4 GHz and 5 GHz. The corresponding antenna input impedances (Ohms) with respect to antenna feed point 22 are 76.65+j89.12, 79.50+j92.62, 78.02+j 90.70, 80.35+j93.19, and 78.92+j91.49, for the 1-5 GHz switch configurations.

Of course, those skilled in the art will immediately appreciate that the five detection frequencies used for the exemplary discussion above are not limiting. In other words, the antenna system 10 according to the present invention can be illustrated to detect and adapt to any number of frequencies and, thus, may include a greater or lesser number of sensor circuits 20, resonator circuits 22, relay control circuits 70, antenna segments 28, and inter-segment switches. Indeed, those skilled in the art will appreciate that the illustrated circuits may be varied as needed or desired, for example, by multiplexing discrete detection and control signals, such that fewer signal lines are required, and that such changes would require corresponding changes in the overall inter-segment switch control circuits.

Indeed, the present invention generally is directed to an antenna system that, in an exemplary embodiment, uses frequency-selective H-field sensors and corresponding micro RF resonators to detect the center frequency of an incident electromagnetic waveform, and adapt the electrical length of a switched-segment antenna responsive to the detected frequency. An exemplary control circuit supporting such adaptation comprises a microprocessor circuit or other digital logic circuit that is programmed or otherwise configured to set the combined segment length of the antenna to a frequency band appropriate for the detected frequency. As such, the present invention is not limited by the foregoing exemplary details, but rather is limited only by the following claims and the reasonable equivalents thereof.

What is claimed is:

1. A method of setting a frequency band of a switched-segment antenna comprising antenna segments that are selectively connected via inter-segment switches, the method comprising:
detecting a frequency of an incident electromagnetic signal using a detection circuit that includes an array of frequency-selective H-field sensors; and
setting a combined segment length of the switched-segment antenna by selectively opening and closing the inter-segment switches to configure the switched-segment antenna for a frequency band corresponding to the detected frequency of the incident electromagnetic signal.

2. The method of claim 1, wherein detecting the frequency of the incident electromagnetic signal using the detection circuit comprises detecting a center frequency of the incident electromagnetic signal using the array of H-field sensors, each tuned to a different center frequency such that a particular one of the H-field sensors responds to the incident electromagnetic signal.

3. The method of claim 1, wherein detecting the frequency of the incident electromagnetic signal comprises:
receiving the incident electromagnetic signal at a plurality of H-field sensors, each tuned to a different frequency response;
coupling sensor output signals from the plurality of H-field sensors to respective ones in a plurality of frequency resonators; and
monitoring resonator output signals from the frequency resonators to determine which H-field sensor responded to the incident electromagnetic signal.

4. The method of claim 3, wherein coupling the sensor output signals from the plurality of H-field sensors to the respective ones in the plurality of frequency resonators comprises downconverting each sensor output signal to a baseband frequency signal, and amplifying the baseband frequency signal for input to the corresponding frequency resonator.

5. The method of claim 3, wherein monitoring the resonator output signals to determine which H-field sensor responded to the incident electromagnetic signal comprises coupling the resonator output signals to a microprocessor circuit that is programmed to identify a frequency band for the incident electromagnetic signal based on monitoring the resonator output signals.

6. The method of claim 3, further comprising coupling the resonator output signals to an antenna interface circuit such that assertion of a particular resonator output signal actuates a corresponding one of the inter-segment switches.

7. The method of claim 6, further comprising further coupling the resonator output signals to a microprocessor circuit for monitoring, and coupling microprocessor-controlled switch control signals to the antenna interface circuit such that a controlling microprocessor circuit opens and closes the inter-segment switches as needed for the desired frequency band responsive to an assertion of a particular resonator output signal.

8. The method of claim 1, further comprising configuring the switched-segment antenna as a non-conductive center support and one or more series of conducting segments surrounding the center support, said conducting segments selectively interconnected via inter-segment switches.

9. The method of claim 8, further comprising running switching control wires from the inter-segment switches in the switched segment antenna to the antenna interface within an interstitial space defined between the center support and the surrounding conducting segments.

10. A switched-segment antenna system comprising:
a switched-segment antenna that includes two or more conductive antenna segments, each segment having a defined length, and one or more inter-segment switches to selectively interconnect neighboring segments such that a combined segment length of the antenna is set by selectively opening and closing the inter-segment switches;
a detection circuit to detect a frequency of an incident electromagnetic signal;
an antenna interface circuit to control the inter-segment switches; and
a control circuit to generate control signals for the antenna interface circuit responsive to monitoring the detection circuit, and thereby set a frequency band of the switched-segment antenna based on the detected frequency of the incident electromagnetic signal.

11. The antenna system of claim 10, wherein the detection circuit includes an array of H-field sensors, each tuned to a particular frequency, such that a center frequency of the incident electromagnetic signal is determined by identifying a particular one of the H-field sensors that responds to the incident electromagnetic signal.

12. The antenna system of claim 11, wherein the detection circuit further includes an array of frequency resonators corresponding to the array of H-field sensors, such that each H-field sensor output signal is coupled to an input of a corresponding frequency resonator.

13. The antenna system of claim 12, wherein the detection circuit further includes, for each sensor output signal, a corresponding mixer circuit and amplifier circuit to down-convert the sensor output signal to a baseband frequency signal and amplify the baseband frequency signal for input to the corresponding frequency resonator.

14. The antenna system of claim 12, wherein the control circuit monitors the detection circuit by monitoring resonator output signals from the array of frequency resonators, wherein assertion of a particular one of the resonator output signals identifies the center frequency of the incident electromagnetic signal.

15. The antenna system of claim 10, wherein the detection circuit generates a plurality of detection output signals, with a particular detection output signal being asserted responsive to the detected frequency of the incident electromagnetic signal.

16. The antenna system of claim 15, wherein the antenna interface circuit comprises a plurality of relay control circuits, each relay control circuit controlling actuation of at least one inter-segment switch and driven by a corresponding one of the detection output signals, such that a particular one or particular ones of the inter-segment switches are closed responsive to the detected frequency of the incident electromagnetic signal.

17. The antenna system of claim 16, wherein each control signal generated by the control circuit drives a particular one of the relay control circuits such that each relay control circuit may be driven by the detection circuit and by the control circuit.

18. The antenna system of claim 17, wherein the control circuit comprises a microprocessor circuit that is programmed to determine a switch configuration corresponding to a desired antenna frequency band that matches the detected frequency of the incident electromagnetic signal, and to set the control signals such that the relay control circuits open and close the inter-segment switches as need to achieve the desired antenna frequency band.

19. The antenna system of claim 10, wherein the switched-segment antenna comprises a non-conductive central support, two or more conductive segments surrounding the central support, and one or more inter-segment switches to selectively connect the two or more conductive segments.

20. The antenna system of claim 19, wherein switch control signal lines from the inter-segment switches connecting the inter-segment switches to the antenna interface circuit run within an interstitial space defined between the central support and the surrounding conductive segments.

21. A switched-segment antenna system comprising:
a switched-segment antenna having an electrical length that is set by selectively opening and closing a plurality of inter-segment switches;
a detection circuit to detect a center frequency of an incident electromagnetic signal; and
a control and interface circuit to set the electrical length of the switched-segment antenna based on the detected center frequency of the incident electromagnetic signal.

22. The system of claim 21, wherein the detection circuit includes a plurality of H-field sensors and a corresponding plurality of resonator circuits, wherein each H-field sensor is tuned to detect a different center frequency.

23. The system of claim 22, wherein the control and interface circuit comprises:
a digital logic circuit and a switch control circuit;
said digital logic circuit having one or more signal inputs coupled to the resonator circuits and one or more signal outputs coupled to the switch control circuit; and
said switch control circuit coupled to the inter-segment switches of the switched-segment antenna such that the digital logic circuit selectively opens and closes the inter-segment switches based on monitoring output signals from the resonator circuits.

24. A method of setting a frequency band of a switched-segment antenna comprising antenna segments that are selectively connected via inter-segment switches, the method comprising:
detecting a frequency of an electromagnetic signal of interest based on monitoring a detection circuit that includes an array of frequency-selective H-field sensors; and
setting a frequency band of the switched segment antenna based on the detected frequency of the electromagnetic signal of interest by controlling the inter-segment switches to selectively connect and disconnect individual ones of the antenna segments.

25. The method of claim 24, further comprising maintaining the inter-segment switches in a current switch configuration until a new frequency is detected via the detection circuit.

26. The method of claim 25, further comprising determining a new switch configuration to change the open or closed state of particular inter-segment switches as needed to change the frequency band of the switched-segment antenna based on the new detected frequency.

27. The method of claim 24, further comprising changing the frequency band of the switched-segment antenna as needed responsive to detecting changed frequencies of the electromagnetic signal of interest, such that the switched-segment antenna operates as an adaptable, multi-band antenna having an electrical length that changes in response to changing center frequencies of the electromagnetic signal of interest.
